(19) United States
(12) Patent Application Publication
(10) Pub. No.: US 2005/0025466 A1
(43) Pub. Date: Feb. 3, 2005

(54) Audio video playing/displaying apparatus with detachable media-accessing device

(76) Inventors: Meng-Shin Yen, Taipei City (TW); Wen-Wei Huang, Taoyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/798,583

(22) Filed: Mar. 10, 2004

(30) Foreign Application Priority Data
Mar. 12, 2003 (TW) 092105288

(51) Int. Cl. H04N 5/781

(52) U.S. Cl. 386/125; 386/126

(57) ABSTRACT

A detachable audio video playing/displaying apparatus includes a detachable media-accessing device, a displaying module, and a locking apparatus. The displaying module includes a monitor and a fixing base. The fixing base for receiving the media-accessing device has a second input/output (I/O) port for connecting with a first I/O port on the media-accessing device. The media-accessing device, such as a portable DVD player, can be detached from the displaying module or be combined with the displaying module into a unity. The locking apparatus includes a locking piece at the front of the fixing base, and a groove on the media-accessing device. When the media-accessing device is placed into the fixing base, the locking piece can be engaged with the groove so that the media-accessing device can be fixed on the fixing base. Signals from the media-accessing device can be output to the monitor via the first and the second I/O ports.

This application claims the benefit of Taiwan application Serial No. 092105228, filed Mar. 12, 2003, the subject matter of which is incorporated herein by reference.

### BACKGROUND OF THE INVENTION

1. Field of the invention

The invention relates in general to an audio video playing/displaying apparatus, and more particularly to an audio video playing/displaying apparatus with a detachable media-accessing device.

2. Description of the Related Art

As technology develops and changes with each passing day, audio/video techniques are increasingly improved. For example, compact disks (CDs), which are easy to keep and have large capacity for storage, have taken the place of typical cassette tapes and phonograph disks. Likewise, digital video disks (DVDs) of a high-density disc format have taken the place of typical videotapes in recording video data. People can enjoy clear and high quality pictures provided by DVD films as a result of the innovation in digital audio/video techniques. For such a reason, the DVD player has become a new favorite for playing films in people's lives nowadays.

A DVD player is typically connected to a TV or a PC for playing DVD films. Besides, it is essential for a family theater to equip with a DVD player, a large TV screen and a stereo set. The DVD player can provide multi-function, such as playing VCD films, CD, and MP3 media besides DVD, which bring people's lives more fun and joyfulness. In addition, a typical portable DVD player is small and light and therefore can be conveniently carried to connect with a TV, a PC, or a liquid crystal displayer (LCD) for playing DVD films. However, such a portable DVD player has to be connected with a monitor for displaying images while playing films. Therefore, the portable DVD player cannot play films when being carried outside without a monitor, thereby reducing its convenience in application.

Moreover, some DVD player, having a LCD integrated with the media player as a unit, can be carried to everywhere to play films like a notebook. What differs is the DVD player with a LCD can only do simple data processing in addition to the essential function of playing DVD and VCD films. The film playing apparatus in the DVD player cannot be detached from the monitor to lower the weight for carrying as needed. Besides, the media player of a notebook computer can only be used to play films in the notebook computer, but can not be detached from the notebook computer to connect a TV, PC or other displayers. As a result, the typical DVD player still has much limitation in its application.

### SUMMARY OF THE INVENTION

It is therefore an object of the invention to provide an improved audio video playing/displaying apparatus with a detachable media-accessing device. The media-accessing device, such as a portable DVD player, can be combined with a monitor into a unity or be detached from the monitor for further application. The monitor can be further combined with other media-accessing device, such as a personal digital assistant (PDA) for processing data or a TV tuner for playing TV programs. Therefore, the variety in application of audio video playing and displaying can be improved.

The invention achieves the above-identified objects by providing an audio video playing/displaying apparatus with a detachable media-accessing device. The audio video playing/displaying apparatus includes a media-accessing device, such as a portable DVD player, a displaying module, and a locking apparatus. The displaying module includes a monitor and a fixing base. The monitor, connected to the fixing base, can be opened or closed relative to the fixing base. The fixing base for receiving the media-accessing device has a second input/output (I/O) port for connecting with a first I/O port at the back of the media-accessing device. The locking apparatus includes a locking piece at the front of the fixing base, and a groove on the media-accessing device. When the media-accessing device is placed into the fixing base, the locking piece is engaged with the groove on the media-accessing device so that the media-accessing device can be fixed on the fixing base. Moreover, the fixing base includes some controlling buttons, which can control the media-accessing device via the second I/O port. The fixing base includes a battery for supplying power to the displaying module. The media-accessing device can be detached from the displaying module individually. When the media-accessing device is combined with the displaying module into a unity, signals from the media-accessing device can be output to the monitor via the first and the second I/O ports. A PDA can be also placed into the fixing base to connect with the displaying module via the second I/O port, or a TV tuner can be placed into the fixing base to connect with the monitor for showing TV programs via the second I/O port. Therefore, the variety in application of audio/video playing and displaying can be enhanced.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a perspective view of an audio video playing/displaying apparatus with a detachable media-accessing device according to a preferred embodiment of the invention;

FIG. 1B is a perspective view of an audio video playing/displaying apparatus with the media-accessing device detached from the displaying module in FIG. 1A;

FIG. 1C is a perspective view of an audio video playing/displaying apparatus with the monitor closed relative to the fixing base in FIG. 1B

FIG. 1D is a rear view of the media-accessing device according to the preferred embodiment of the invention; and

FIG. 1E is a lateral view of an audio video playing/displaying apparatus and a detachable media-accessing device according to the preferred embodiment of the invention.

### DETAILED DESCRIPTION OF THE INVENTION

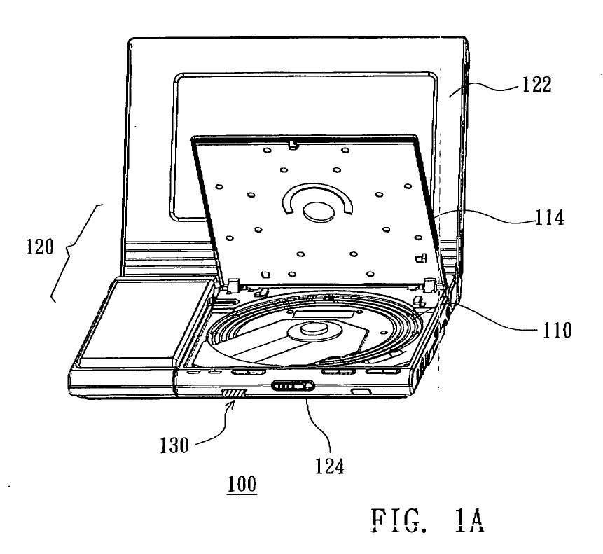

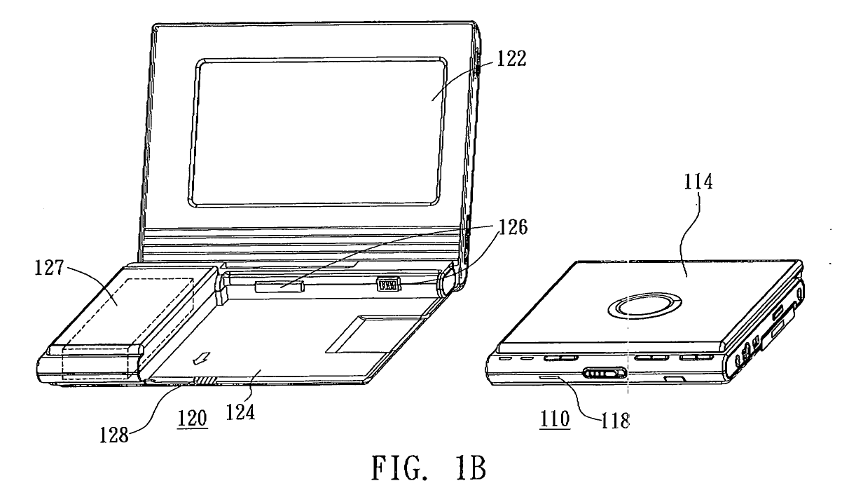

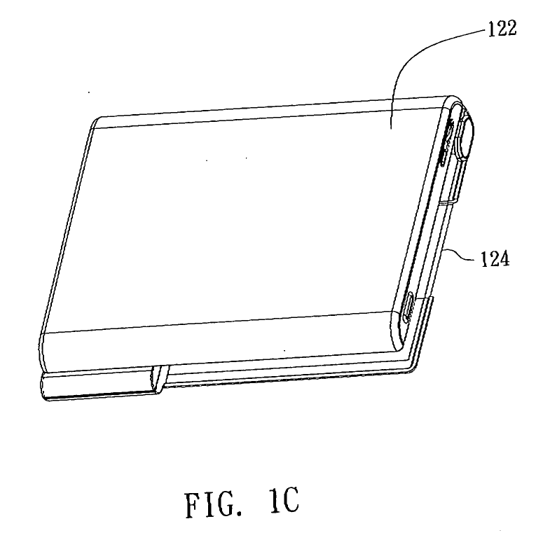

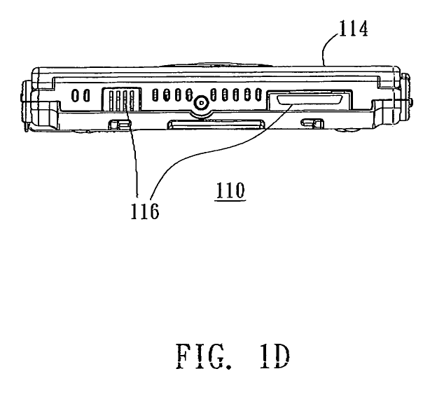

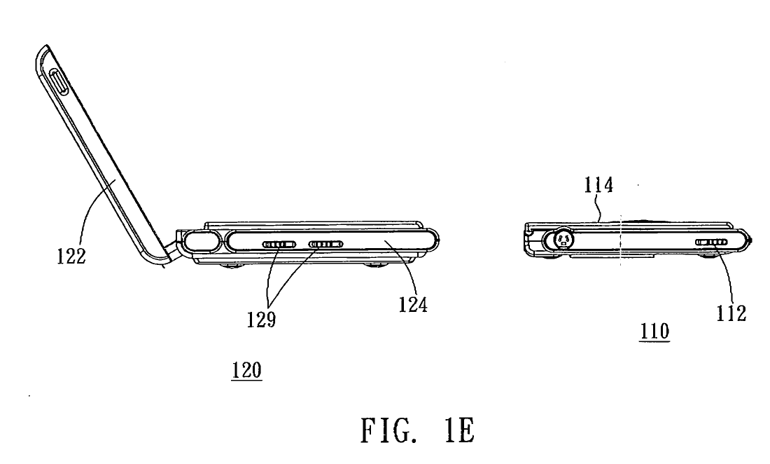

Referring to FIG. 1A, a perspective view of an audio video playing/displaying apparatus with a detachable media-accessing device according to a preferred embodiment of the invention is shown. In FIG. 1A, the audio video playing/displaying apparatus 100 includes a media-accessing device 110, a displaying module 120, and a locking apparatus 130. The media-accessing device 110 can be a portable DVD player having an upper cover or having a tray for receiving an audio/video disc so that the audio/video disc can be drawn out or pushed back at one side of the displaying module. The media-accessing device 110 can be combined with the displaying module into a unity as shown in FIG. 1A. The media-accessing device 110 can also be detached from the monitor. Referring to FIG. 1B, a perspective view of an audio video playing/displaying apparatus with the media-accessing device 110 detached from the displaying module 120 in FIG. 1A is shown. In FIG. 1B, the displaying module 120 includes a monitor 122 and a fixing base 124. The monitor 122, such as a LCD, can be opened or closed relative to the fixing base 124. FIG. 1C shows that the monitor 122 is closed relative to the fixing base 124. The fixing base 124 is used for receiving the media-accessing device 110.

As shown in FIG. 1A, when the media-accessing device 110, such as a portable DVD player having an upper cover, is put into the fixing base 124 and the monitor 122 is opened relative to the fixing base 124, the upper cover 114 of the portable DVD player can be opened or closed.

In addition, as shown in FIG. 1B, the fixing base 124 has a second I/O port 126, which is connected with a first I/O port 116 (as shown in FIG. 1D) at the back of the media-accessing device 110 to transfer signals from the device 110 to the monitor 122 when the device 110 is combined with the displaying module 120. Moreover, the fixing base 124 includes a battery 127 for supplying power to the monitor 122.

Referring to FIG. 1A and FIG. 1B, the locking apparatus 130 mentioned above includes a locking piece 128 located at the front of the fixing base 124, and a groove 118 at the front of the media-accessing device 110. The locking piece 128 can shift along the direction as the arrow shown in FIG. 1B. When the media-accessing device 110 is put into the fixing base 124, the locking piece 128 of the fixing base 124 is engaged with the groove 118 of the media-accessing device 110 so that the media-accessing device 110 is fixed in the displaying module 120. When the locking piece 128 is pressed off the groove 118 by hand, the media-accessing device 110 can be taken from the displaying module 120.

For convenience, the media-accessing device 110, such as a portable DVD player, can be detached from the displaying module 120 and carried to other places such that the portable DVD player can be connected to a TV, a PC, or other monitors for playing DVD films as needed. Alternatively, the portable DVD player can be fixed into the fixing base 124 by the locking apparatus 130 such that the media-accessing device 110 and the displaying module 120 can be carried outside together. Signals from the portable DVD player are output to the monitor 122 for playing DVD films via the first I/O port 116 and the second I/O port 126 on the fixing base 124.

Besides, referring to FIG. 1A and FIG. 1E, when the media-accessing device 110 is combined with the displaying module 120, the device 110 is integrated with the displaying module 120 as shown in FIG. 1A. Therefore, some controlling buttons 112 (as shown in FIG. 1E) on the media-accessing device 110, such as a lock button or a power button, will be sheltered from being controlled externally. For this reason, controlling buttons 129, having the same functions as the controlling buttons 112, are designed on one side of the fixing base 124 in the invention. When the media-accessing device 110 is put into the fixing base 124, these controlling buttons 129 can be used to control the media-accessing device 110 via the second I/O port 126 instead of the controlling buttons 112.

The media-accessing device 110 can be a PDA. When the PDA is combined with the displaying module 120, operations on the PDA will be shown upon the monitor 122 more clearly than on the PDA itself. The media-accessing device 110 can also be a TV tuner. When the TV tuner is combined with the displaying module 120, TV programs will be played on the monitor 122. Furthermore, the battery 127 supplies power to the media-accessing device 110.

The feature of the audio video playing/displaying apparatus in the invention lies in the media-accessing device. For example, a portable DVD player can be combined with the displaying module into a unity and then can be carried conveniently for playing DVD films at anytime in anyplace. The portable DVD player can also be detached from the displaying module individually in order to lighten the weight for carrying. The detached portable DVD player can be connected to a TV, a PC, or other monitors for playing DVD films whenever it is needed. Moreover, when the portable DVD player is detached from the displaying module, the displaying module can be further combined with a PDA for showing the operations on the PDA or be combined with a TV tuner for playing TV programs. Therefore, the variety in application of audio/video playing and displaying can be enhanced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A detachable audio video media playing/displaying apparatus, comprising:
a media-accessing device including a first I/O port;
a displaying module including
a fixing base for receiving the media-accessing device, the fixing base including a second I/O port for being connected to the first I/O port, and
a monitor capable of being opened or closed relative to the fixing base; and
a locking apparatus for fixing the media-accessing device on the displaying module when the media-accessing device is combined with the displaying module;
wherein the media-accessing device is detachable from the displaying module, and the media-accessing device outputs signals to the monitor via the first and the second I/O ports when the media-accessing device is put into the fixing base and combined with the displaying module.

2. The apparatus according to claim 1, wherein the fixing base has a controlling button, which can control the media-accessing device via the second I/O port.

3. The apparatus according to claim 2, wherein the controlling button is a lock button.

4. The apparatus according to claim 2, wherein the controlling button is a power button.

5. The apparatus according to claim 1, wherein the locking apparatus comprises a locking piece at a front of the fixing base, and a groove on the media-accessing device.

6. The apparatus according to claim 5, wherein the locking piece is engaged with the groove when the media-accessing device is combined with the displaying module, and the media-accessing device can be taken from the displaying module when the locking piece is pressed off the groove by hand.

7. The apparatus according to claim 1, wherein the media-accessing device is a portable DVD player.

8. The apparatus according to claim 1, wherein the media-accessing device is a Personal Digital Assistant (PDA).

9. The apparatus according to claim 1, wherein the media-accessing device is a TV tuner.

10. The apparatus according to claim 1, wherein the monitor is a liquid crystal displayer (LCD).

11. A detachable audio video media playing/displaying apparatus, comprising:
a portable DVD player including a first I/O port;
a displaying module including:
a fixing base for receiving the portable DVD player, the fixing base including
a second I/O port for being connected to the first I/O port, and
a battery for supplying power to the displaying module;
a monitor capable of being opened or closed relative to the fixing base; and
a locking apparatus for fixing the portable DVD player on the displaying module when the portable DVD player is combined with the displaying module;
wherein the portable DVD player is detachable from the displaying module, and DVD films can be played on the monitor via the first and the second I/O ports when the portable DVD player is put into the fixing base and combined with the displaying module.

12. The apparatus according to claim 11, wherein the fixing base has a controlling button, which can control the portable DVD player via the second I/O port.

13. The apparatus according to claim 12, wherein the controlling button is a lock button.

14. The apparatus according to claim 12, wherein the controlling button is a power button.

15. The apparatus according to claim 11, wherein the portable DVD player has an upper cover.

16. The apparatus according to claim 15, wherein the upper cover of the portable DVD player can be opened or closed when the DVD player is combined with the displaying module and the monitor is opened.

17. The apparatus according to claim 11, wherein the portable DVD player has a tray for receiving a DVD, which can be drawn out and pushed back at one side of the fixing base.

18. The apparatus according to claim 11, wherein the battery supplies power for the portable DVD player as well as the displaying module.
